(19) United States
(12) Patent Application Publication
(10) Pub. No.: US 2014/0022386 A1
(43) Pub. Date: Jan. 23, 2014

(54) INFORMATION DISPLAY METHOD AND DEVICE

(71) Applicants: Lenovo (Beijing) Co., Ltd., Beijing (CN); Beijing Lenovo Software Ltd, Beijing (CN)

(72) Inventor: Yong Zhi, Beijing (CN)

(73) Assignees: Lenovo (Beijing) Co., Ltd., Beijing (CN); Beijing Lenovo Software Ltd, Beijing (CN)

(21) Appl. No.: 13/948,421

(22) Filed: Jul. 23, 2013

(30) Foreign Application Priority Data
Jul. 23, 2012 (CN) 201210256755.9

(51) Int. Cl. G06F 17/28

(52) U.S. Cl. CPC G06F 17/28
USPC 348/143

(57) ABSTRACT

The invention provides an information display method and an information display device. The information display method is applicable in an electronic device including an image projecting module and an image acquiring module, a projection region of the image projecting module at least partially overlapping with an acquiring region of the image acquiring module. The method includes: determining a first image acquiring region in which an acquisition object is at least partially located; acquiring, by the image acquiring module, at least a part of the acquisition object in the first image acquiring region and determining a first processing object; performing image recognizing process on the first processing object and generating first information; processing the first information and generating second information; determining the projection region in which the acquisition object is at least partially located; and projecting, by the image projecting module, the second information into the projection region.

### CROSS REFERENCE TO RELATED APPLICATION

This application claims the benefit of priority to Chinese Patent Application No. 201210256755.9, entitled “INFORMATION DISPLAY METHOD AND DEVICE”, filed on Jul. 23, 2012 with State Intellectual Property Office of PRC, which is incorporated herein by reference in its entirety.

### FIELD OF THE INVENTION

The invention relates to the field of intelligent terminals, and in particular, to an information display method and an information display device.

### BACKGROUND OF THE INVENTION

At present, electronic devices such as mobile-phone, PAD have more and more applications, such as translation application, searching application or an information processing application, providing various applications for users. In the case that a user encounters an unfamiliar word when reading a book in a foreign language, the user may input the word into a translation application in a smart-phone to find out the meaning of the word. However, this operation is not convenient because the user has to input the word manually. In the art there is another application in which a word is captured by a camera in a smart-phone and a translation of the word is presented on the phone in real time. Compared to the previous manner, this manner is more convenient because the user does not need to input the word manually. However, each of the two manners has the disadvantage that the user has to switch his/her sight between the book and the screen of the phone, resulting in an inconvenience for the user.

### SUMMARY OF THE INVENTION

To solve the above technical problem, embodiments of the invention provide an information display method and an information display device, by which a user does not have to switch the sight and the user experience is improved. The solutions are as follows.

In one aspect, embodiments of the invention provide an information display method applicable in an electronic device including an image projecting module and an image acquiring module, in which a projection region of the image projecting module at least partially overlapping with an acquiring region of the image acquiring module. The method includes:

determining a first image acquiring region in which an acquisition object is at least partially located;

acquiring, by the image acquiring module, at least a part of the acquisition object in the first image acquiring region and determining a first processing object;

performing an image recognizing process on the first processing object and generating first information;

processing the first information and generating second information;

determining the projection region in which the acquisition object is at least partially located; and

projecting, by the image projecting module, the second information into the projection region.

Preferably, the method further includes:

projecting, by the image projecting module, a boundary of a second image acquiring region, where the second image acquiring region is located within the first image acquiring region; and

determining a first processing object includes:

determining an image in the second image acquiring region as the first processing object.

Preferably, the method further includes:

adjusting the size of the boundary of the second image acquiring region.

Preferably, adjusting the size of the boundary of the second image acquiring region includes:

receiving a first input instruction, and adjusting the size of the boundary of the second image acquiring region according to the first input instruction, wherein the first input instruction is a keystroke input or a gesture input;

or

recognizing the image in the second image acquiring region, and adjusting the size of the boundary of the second image acquiring region according to a recognition result.

Preferably, determining a first processing object includes:

recognizing an acquired image in the first image acquiring region, and obtaining the first processing object according to a first preset condition, wherein the first preset condition is a preset indicator or preset information of interest.

Preferably, determining the projection region includes:

obtaining a location where the first processing object is located in the first image acquiring region or in the acquisition object, and determining a location of the projection region according to the location.

Preferably, determining the projection region includes:

searching for a region satisfying a second preset condition and determining the region as the projection region.

Preferably, determining the projection region includes:

obtaining a location where the first processing object is located in the first image acquiring region or a location where the first processing object is located at the acquisition object, and determining the region of the location as the projection region.

Preferably, projecting, by the image projecting module, the second information into the projection region includes:

obtaining first color information of the acquisition object in the determined projection region, and determining second color information according to the first color information, wherein the first color information and the second color information satisfy a third preset condition; and

projecting the second information into the projection region by using the second color information.

Preferably, the first color information is background color information of the acquisition object.

Preferably, processing the first information and generating second information includes any one of the following steps:

performing a translation process on the first information, and taking a translation result as the second information;

performing a searching process on the first information, and acquiring a search result related to the first information as the second information; and

performing a recognizing and extracting process on the first information, and obtaining result information corresponding to a recognition and extraction result as the second information.

Preferably, the method further includes:

performing a searching process on the result information corresponding to the recognition and extraction result, generating third information, and projecting the third information into the projection region.

In another respect, the embodiments of the invention further discloses an information display device having an image projecting module and an image acquiring module, in which a projection region of the image projecting module at least partially overlapping with an acquiring region of the image acquiring module. The device includes:

a first determining module, configured to determine a first image acquiring region in which an acquisition object is at least partially located;

an image acquiring module, configured to acquire at least a part of the acquisition object in the first image acquiring region and determine a first processing object;

an image recognizing module, configured to perform an image recognizing process on the first processing object and generate first information;

a processing module, configured to process the first information and generate second information;

a second determining module, configured to determine the projection region in which the acquisition object is at least partially located; and

an image projecting module, configured to project the second information into the projection region.

Preferably, the image projecting module is further configured to project a boundary of a second image acquiring region, wherein the second image acquiring region is located within the first image acquiring region;

then the image acquiring module is further configured to determine an image in the second image acquiring region as the first processing object.

Preferably, the device further includes:

an adjusting module, configured to adjust the size of the boundary of the second image acquiring region.

Preferably, the adjusting module includes:

a first adjusting module, configured to receive a first input instruction and adjust the size of the boundary of the second image acquiring region according to the first input instruction, wherein the first input instruction is a keystroke input or a gesture input; and

a second adjusting module, configured to recognize, by using the image recognizing module, the image in the second image acquiring region and adjust the size of the boundary of the second image acquiring region according to a recognition result.

Preferably, the image acquiring module is further configured to recognize an acquired image in the first image acquiring region, and obtain the first processing object according to a first preset condition, wherein the first preset condition is a preset indicator or preset information of interest.

Preferably, the second determining module includes:

a first determining unit, configured to obtain a location relation between the first image acquiring region and the first processing object, and determine a location of the projection region according to the location relation;

a second determining unit, configured to search for a region satisfying a second preset condition and determine the region as the projection region; and

a third determining unit, configured to obtain a location where the first processing object is located in the acquisition object, and determine the region of the location as the projection region.

Preferably, the image projecting module is further configured to obtain first color information of the acquisition object in the determined projection region, determine second color information according to the first color information, and project the second information into the projection region by using the second color information, wherein the first color information and the second color information satisfy a third preset condition.

Preferably, the processing module includes:

a first processing unit, configured to perform a translation process on the first information and take the translation result as the second information;

a second processing unit, configured to perform a searching process on the first information, and obtain a search result related to the first information as the second information; and

a third processing unit, configured to perform a recognizing and extracting process on the first information, and obtaining result information corresponding to a recognition and extraction result as the second information.

Preferably, the processing module further includes:

a fourth processing unit, configured to perform a searching process on the result information corresponding to the recognition and extraction result, generate third information, and project the third information into the projection region.

The advantageous effect of the invention is as follows. The method provided in the embodiments of the invention is applicable in an electronic device including an image projecting module and an image acquiring module, in which a projection region of the image projecting module and an acquiring region of the image acquiring module at least partially overlap with each other. Firstly, a first image acquiring region is determined, in which the first image acquiring region and an acquisition object at least partially overlap with each other. A first processing object is determined by acquiring the acquisition object in the first image acquiring region, and the first processing object is processed to generate second information, then the second information is projected onto the acquisition object by the image projecting module. By the method provided in the embodiments of the invention, because the first processing object viewed by a user and the processed information displayed by projection are both on the acquisition object (i.e. on the viewed object), the user do not have to switch the sight between the viewed object and a screen of a phone, resulting in an convenience for the user.

### BRIEF DESCRIPTION OF THE DRAWINGS

Technical solutions of the embodiments of the present applicant and/or the prior art will be illustrated more clearly with the following brief description of the drawings. Apparently, the drawings referred in the following description constitute only some embodiments of the invention. Those skilled in the art may obtain some other drawings from these drawings without any creative effort.

FIG. 1 is a flowchart of an information display method provided according to a first embodiment of the invention;

FIG. 2 is a flowchart of an information display method provided according to a second embodiment of the invention;

FIG. 3 is a flowchart of an information display method provided according to a third embodiment of the invention; and

FIG. 4 is a schematic diagram of an information display device provided by an embodiment of the invention.

### DETAILED DESCRIPTION OF THE INVENTION

The embodiments of the invention provide an information display method and an information display device by which a user does not have to switch the sight and the user experience is improved.

To make a better understanding of technical solutions in the present invention for those skilled in the art, the technical solutions according to the embodiments of the present invention will be described clearly and completely as follows in conjunction with the drawings. It is obvious that the described embodiments are only some of the embodiments according to the present invention. Any other embodiments obtained by those skilled in the art based on the embodiments in the present invention without any creative work fall within the protection scope of the present invention.

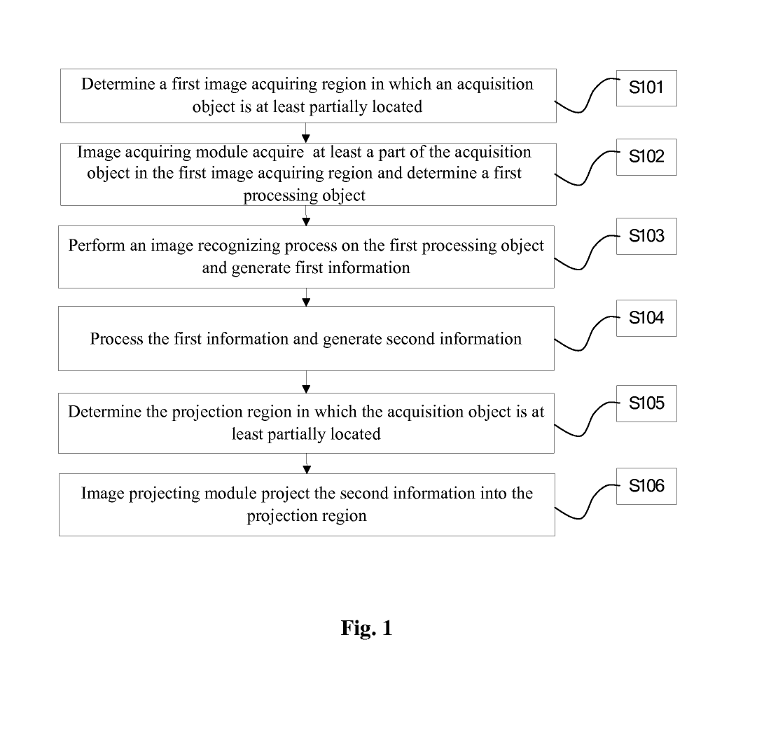

FIG. 1 is a flowchart of an information display method provided according to a first embodiment of the invention.

An information display method provided in an embodiment of the invention is applicable in an electronic device including an image projecting module and an image acquiring module, in which a projection region of the image projecting module at least partially overlaps with an acquiring region of the image acquiring module. The electronic device includes but does not limit to a mobile-phone, a camera, a PAD and the like.

S101, determining a first image acquiring region in which an acquisition object is at least partially located.

In the embodiment, the electronic device includes an image projecting module and an image acquiring module. When the image acquiring module in the electronic device is started, the electronic device is in a state of standing by for shooting a photo. The electronic device may have a viewfinder screen to preview an image to be acquired. Further, after the electronic device detects that an image in a viewfinder frame or in an image acquiring region stands still for a time period, for example, for 2 seconds or 3 seconds, the electronic device determines the range covered by the viewfinder frame as the first image acquiring region. A part or all parts of the acquisition object are located in the first image acquiring region.

S102, acquiring, by the image acquiring module, at least a part of the acquisition object in the first image acquiring region and determining a first processing object.

After receiving from a user an instruction for shooting a photo, the image acquiring module of the electronic device acquires an image in the first image acquiring region. At least a part of the acquisition object is located in the first image acquiring region. At this point, the first processing object is determined from the acquired image.

S103, performing an image recognizing process on the first processing object and generating first information.

S104, processing the first information and generating second information.

The step S104 includes any one of the following:

performing a translation process on the first information, and taking a translation result as the second information;

performing a searching process on the first information, and acquiring a search result related to the first information as the second information; and

performing a recognizing and extracting process on the first information, and obtaining result information corresponding to a recognition and extraction result as the second information.

Further, the method includes:

performing a searching process on the result information corresponding to the recognition and extraction result, generating third information, and projecting the third information into the projection region.

S105, determining the projection region in which the acquisition object is at least partially located;

S106, projecting, by the image projecting module, the second information into the projection region.

In the first embodiment of the invention, a first image acquiring region is firstly determined. The acquisition object is acquired by the image acquiring module in the first image acquiring region and a first processing object is determined. The first processing object is processed to generate second information, and the second information is projected on the acquisition object by the image projecting module. In the method provided in the embodiments of the invention, because the first processing object viewed by a user and processed information displayed by projecting are both presented on the acquisition object (i.e. on the viewed object), the user does not have to switch the sight between the viewed object and a screen of a phone, resulting in an convenience for the user.

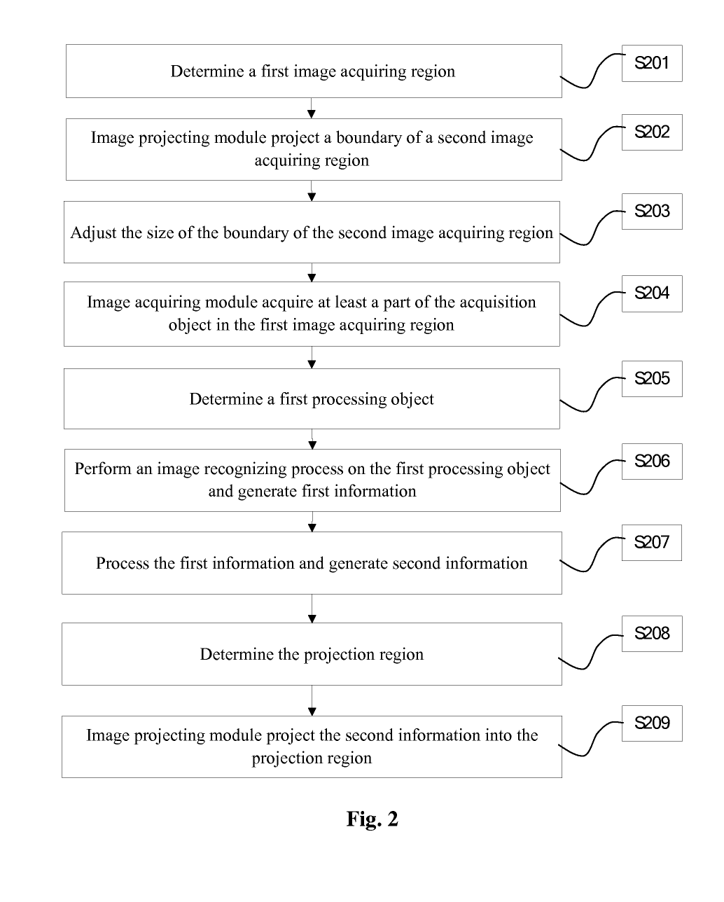

FIG. 2 is a flowchart of an information display method provided according to a second embodiment of the invention.

S201, determining a first image acquiring region.

An acquisition object has at least a part located in the first image acquiring region. A first processing object to be processed ultimately by a user is located in the first image acquiring region.

S202, projecting, by the image projecting module, a boundary of a second image acquiring region.

In the second embodiment of the invention, taking a translation processing as an example, a second image acquiring region may be projected on an acquisition object such as a book by an image projecting module, and the second image acquiring region is located within the first image acquiring region. The image within the boundary of the second image acquiring region is the object to be processed by the electronic device. A specific form of the second image acquiring region may be a word selecting box, and the content in the word selecting box is the object to be processed. The user may select the object to be processed, such as a word to be translated, by adjusting the location of the word selecting box. The size of the boundary of the second image acquiring region may be either fixed or adjustable. In the case that the size of the boundary of the second image acquiring region is fixed, the size of the boundary of the second image acquiring region may be set according to experience or a user setting. When the electronic device projects a second image acquiring region with a fixed size, the process proceeds to step S204.

In the case that the size of the boundary of the second image acquiring region is adjustable, the method provided by the embodiment of the invention may further include step S203.

S203, adjusting the size of the boundary of the second image acquiring region.

Step S203 may include:

receiving a first input instruction, and adjusting the size of the boundary of the second image acquiring region according to the first input instruction, wherein the first input instruction is a keystroke input or a gesture input. That is to say, the electronic device may adjust the size of the boundary of the second image acquiring region according to an input instruction from the user, such as a keystroke input or a gesture input.

On the other hand, the electronic device may adaptively adjust the size of the boundary of the second image acquiring region. In this case, the step S203 includes: recognizing the image in the second image acquiring region, and adjusting the size of the boundary of the second image acquiring region according to a recognition result. Still taking the translation processing as an example, the boundary of the second image acquiring region is projected by the image projecting module of the electronic device, and an image in the first image acquiring region is acquired by the image acquiring module. The boundary of the second image acquiring region may not completely cover a word for which the translation is desired by the user, and in this case the electronic device performs an image recognizing process on the acquired image, compares the range of the recognized word with the range of the second image acquiring region, and adjusts the size of the boundary of the second image acquiring region dynamically according the comparison result so as to cover the range of the word completely.

S204, acquiring, by the image acquiring module, at least a part of the acquisition object in the first image acquiring region.

S205, determining a first processing object.

In the second embodiment of the invention, the boundary of the second image acquiring region is projected by the image projecting module, and the image within the second image acquiring region is the first processing object.

S206, performing an image recognizing process on the first processing object and generating first information.

Here, the first information is a recognition result obtained by performing the image recognizing process on the first processing object. Taking a translation processing as an example, the first information is the spelling of the word obtained by image recognizing.

S207, processing the first information and generating second information.

In the second embodiment of the invention, the step S207 includes: performing a translation process on the first information, and taking a translation result as the second information. Specifically, it is possible to translate a word by using translation software in the electronic device and take the translation result as the second information. It is also possible to send the first information to a cloud-server for translation in the cloud-server and return the translation result to the electronic device.

S208, determining the projection region.

At least a part of the acquisition object is located in the projection region, and the projection region at least partially overlaps with the first image acquiring region. Specifically, the location of the projection region may be fixed. For example, the projection region may be set to be located at the lower side of the first processing object. Still taking the translation processing as an example, a translation result obtained by translating a word may be projected directly to the lower side of the word. Of course, the project region may be set at the right side, the left side or the upper side of the first processing object.

The location of the projection region may also be unfixed. For example, the location of the projection region may be determined according to a location relation between the first processing object and the first image acquiring region or a location relation between the first processing object and the acquisition object. In this case, the way of determining the projection region may be: obtaining a location relation between the first image acquiring region and the first processing object or obtaining a location relation between the acquisition object and the first processing object, and determining the location of the projection region according to the location relation. Specifically, it is possible to acquire, by an image recognizing process, the relative location relation between the first processing object and the first image acquiring region or the relative location relation between the first processing object and the acquisition object, and determine the location of the projection region according the location relation. For example, in the case that a word to be processed is located on the lower half of a book and the information is to be projected to a fixed location, for example, to the lower side of the processing object, the projected information may go beyond the range of the book such that the content of the projected information can not be viewed clearly. Therefore, the location of the projection region may be determined according to a location where the first processing object is located in the first image acquiring region or a location where the first processing object is located at the acquisition object. For example, in the case that the processing object is located at the lower side of the first image acquiring region or at the lower side of the acquisition object, the projection region may be set at the upper side of the first image acquiring region or at the upper side of the processing object; in the case that the processing object is located at the left side of the first image acquiring region or at the left side of the acquisition object, the projection region may be set at the right side of the first image acquiring region or at the right side of the processing object. Moreover, the following setting is also possible: in the case that all parts of the acquisition object are acquired by the image acquiring module, the location of the projection region is determined according to a relative location relation between the acquired processing object and the acquisition object; in the case that only a part of the acquisition object is acquired by the image acquiring module, the location of the projection region is determined according to a relative location relation between the acquired processing object and the first image acquiring region.

In a specific implementation of the invention, it is possible to overlay an original processing object with generated second information. For example, in the case that a translation application is used, a translation result may be projected directly at the location of the processing object such that the user may view the translated word directly with a better user experience. In this implement, the manner of determining the projection region includes: obtaining a location where the first processing object is located at the acquisition object, and determining the region of the location as the projection region.

For a better display effect, another possible implementation for determining the projection region includes: searching for a region satisfying a second preset condition and determining the region as the projection region. For example, a blank region in the acquisition object or in the first image acquiring region may be selected as the projection region. Or a blank region which is nearest to the processing object may be searched out as the projection region to project the second information in the blank region. Further, an indicating line may be displayed to associate the projected second information with the processing object, and the indicating line may be displayed continuously.

S209, projecting, by the image projecting module, the second information into the projection region.

After the projection region is determined, the generated second information may be projected into the projection region by the image projecting module of the electronic device.

The second information may be projected with a fixed color, such as a color with higher lightness. The color may also be different according to different application scenarios. Specifically, it is possible to obtain the projected color by establishing a corresponding relation between application scenarios and colors, and project the second information into the projection region with the obtained color. For example, in the case of performing the translation process to the first processing object, the projection may be in the color of blue, red and the like, because the acquisition object such as a book is normally in the form of black characters on white paper. As another example, in the case that the first processing object is a two-dimensional code, the projection may be in the color either the same as or different from the color used in the translation process.

For a better enhanced display effect, it is also possible to obtain first color information of the acquisition object in the determined projection region, determine second color information according to the first color information, and project the second information into the projection region according to the second color information, in which the first color information and the second color information satisfy a third preset condition. Here, the third condition may be that there is enough visual difference between two colors. Specifically, the color of the projection may be determined according to the information about the brightness, lightness, saturation and the like of the acquisition object in the projection region. For example, in the case that the acquisition object in the projection region is in red, blue may be used as the second color to satisfy the visual difference requirement. Sometimes, the acquisition object in the projection region is not in a single color. In this case, the background color of the acquisition object may be preferably determined as the first color information. Certainly, it is possible to determine the front color of the projected second information according to the obtained front color of the acquisition object, and determine the background color of the projection region according to the obtained background color of the acquisition object. The above are only possible implementations of the invention, and should not be regard as limitation to the invention.

In the second embodiment of the invention, an object to be processed is determined by projecting a boundary of the second image acquiring region using the image projecting module, and an enhanced display effect is achieved by determining the projection region and the color of the projected second information. Therefore, not only the effect that the user does not have to switch the sight between the viewed object and the electronic device is achieved, but also a better display effect is achieved.

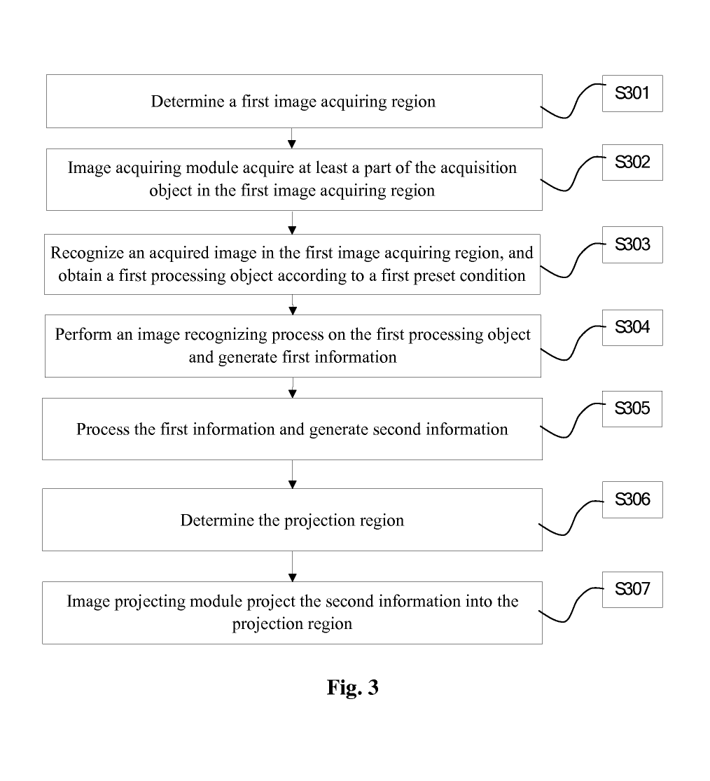

FIG. 3 is a flowchart of an information display method provided according to a third embodiment of the invention.

S301, determining a first image acquiring region.

At least a part of an acquisition object is located in the first image acquiring region. A first processing object to be processed ultimately by a user is located in the first image acquiring region.

S302, acquiring, by the image acquiring module, at least a part of the acquisition object in the first image acquiring region;

S303, recognizing an acquired image in the first image acquiring region, and acquiring a first processing object according to a first preset condition.

The third embodiment of the invention differs from the second embodiment in that the step of projecting a boundary of the second image acquiring region is omitted. As a result, the determining of the first processing object is also different. Specifically, step S303 includes:

recognizing the acquired image in the first image acquiring region, and obtaining the first processing object according to the first preset condition, where the first preset condition is a preset indicator or preset information of interest.

In the following illustration is made by describing a specific implementation. A user may use an indicator such as a finger to indicate an object to be processed on the acquisition object. For example, when the user encounters an unfamiliar word in foreign language when reading a book, the users may point to the word to be translated by a finger on the book (the acquisition object). At this time, an image acquiring module of an electronic device acquires an image in the first image acquiring region, in which the image contains the finger of the user and the object pointed by the finger. Then an image recognizing module of the electronic device recognizes the acquired image. When the finger is recognized, the object pointed by the finger tip may be determined as the object to be processed. The preset condition may also be, for example, preset information of interest satisfying a condition. For example, the image recognizing module may automatically recognize objects to be processed such as all of the English words, all obscure words, or polyphonic words in the acquired image in the image acquiring region, each of which may be taken as the preset information of interest. When the information of interest satisfying the above conditions is recognized by the image recognizing module, it is determined as the first processing object.

S304, performing an image recognizing process on the first processing object and generating first information.

Here, the first information is a recognition result obtained by performing the image recognizing process on the first processing object. Taking a translation processing as an example, the first information is the spelling of a word obtained by image recognizing.

S305, processing the first information and generating second information.

This step may include performing a translation process, a searching process, a recognizing process or the like on the first information, and taking a translation result, a searching result, a recognition result as the second information.

S306, determining the projection region.

In the third embodiment of the invention, the projection region may be determined in a same way as that in the second embodiment. In addition, another possible implement different from the second embodiment is as follows:

the location of the preset indicator is obtained and the region indicated by the preset indicator is determined as the projection region. For example, a user may use the indicator such as a finger to indicate an object to be processed on the acquisition object, and the region indicated by the indicator may be determined as the projection region. In the case that A is pointed by a finger of the user, the generated second information is displayed at the back of A. When the user points to an object to be processed, the second information is displayed in the region indicated by the indicator; when the indicator is left, the second information is not displayed any longer, without disturbing the user from viewing other contents.

S307, projecting, by the image projecting module, the second information into the projection region.

The implementation of the step S307 may be the same as that of the step S209.

In the third embodiment of the invention, the object to be processed may be determined automatically according to a preset condition, and an enhanced display effect may be achieved by determining the projection region and the color of the projected second information, resulting in a better user experience.

The method provided by the invention may be applied to various application scenarios. For example, it is possible to acquire an image of a character on a book, recognize the image of the character and obtain a recognition result, translate the recognition result and obtain a translation result, and project the translation result on the book as the second information. As another example, it is possible to shoot a photo of a product, search for the product and acquire related information such as price, parameters, comments of the product, and project the related information on the product. In this application scenario, it is not necessary to recognize the image of the product. It is possible to search for the product by using either the acquired image of the product or the information obtained by an image recognizing process. For example, it is possible to shoot a photo of a bar code or a two-dimensional code, perform an image recognizing process on the two-dimensional code, then perform a recognizing and extracting process on recognized information, and project a recognition and extraction result as the second information. Further, it is possible to perform searching for the recognition and extraction result and generate third information, and project both the recognition and extraction result and the third information generated by searching into the projection region. Specifically, the acquired two-dimensional code of the product is recognized to obtain a recognition result, which may be a serial of numbers. The serial of numbers may be further recognized to extract specific information of the product, and searching may be further performed for the specific information to obtain more related information. Both of the information of the product and searched results may be projected on the product.

The above are only a few of preferable application scenarios provided by the embodiments of the invention, and the invention is not limit to any specific application scenarios.

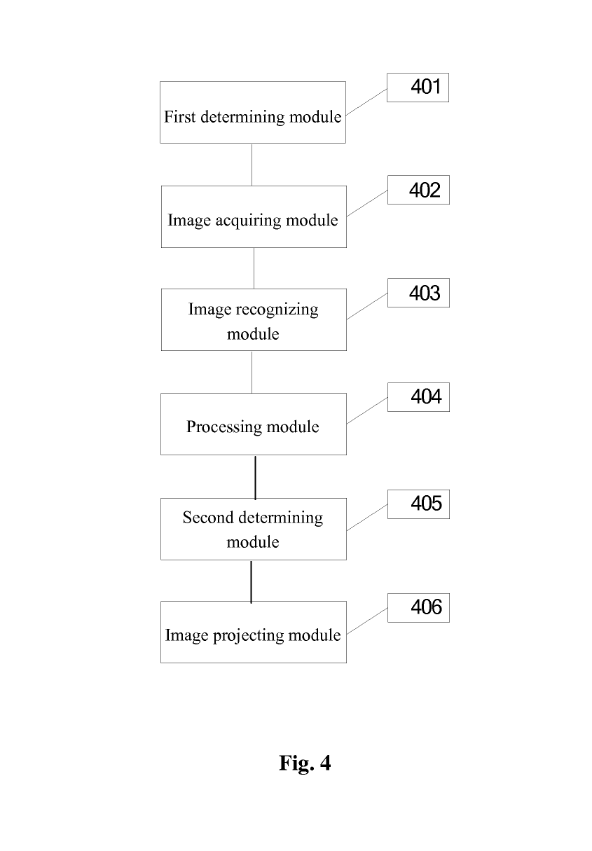

FIG. 4 is a schematic diagram of an information display device provided by an embodiment of the invention.

The embodiments of the invention further provide an information display device including an image projecting module and an image acquiring module, in which a projection region of the image projecting module at least partially overlaps with an acquiring region of the image acquiring module. The device includes:

a first determining module 401, configured to determine a first image acquiring region in which an acquisition object is at least partially located;

an image acquiring module 402, configured to acquire at least a part of the acquisition object in the first image acquiring region and determine a first processing object;

an image recognizing module 403, configured to perform an image recognizing process on the first processing object and generate first information;

a processing module 404, configured to process the first information and generate second information;

a second determining module 405, configured to determine the projection region in which the acquisition object is at least partially located; and

an image projecting module 406, configured to project the second information into the projection region.

The information display device includes the image acquiring module, which may be a camera. The information display device further includes the image projecting module, in which the image acquiring module having a direction the same as a projecting direction of the image projecting module is provided near the image projecting module.

Further, the image projecting module is configured to project a boundary of a second image acquiring region which is located within the first image acquiring region;

and the image acquiring module is further configured to determine an image in the second image acquiring region as the first processing object.

Further, the device includes:

an adjusting module, configured to adjust the size of the boundary of the second image acquiring region.

Further, the adjusting module includes:

a first adjusting module, configured to receive a first input instruction and adjust the size of the boundary of the second image acquiring region according to the first input instruction, wherein the first input instruction is a keystroke input or a gesture input; and

a second adjusting module, configured to recognize, by using the image recognizing module, the image in the second image acquiring region and adjust the size of the boundary of the second image acquiring region according to a recognition result.

Further, the image acquiring module is configured to recognize the acquired image in the first image acquiring region, and obtain the first processing object according to a first preset condition, wherein the first preset condition is a preset indicator or preset information of interest.

Further, the second determining module includes:

a first determining unit, configured to obtain a location relation between the first image acquiring region and the first processing object, and determine a location of the projection region according to the location relation;

a second determining unit, configured to search for a region satisfying a second preset condition and determine the region as the projection region; and

a third determining unit, configured to obtain a location where the first processing object is located in the acquisition object, and determine the region of the location as the projection region.

Further, the image projecting module is further configured to obtain first color information of the acquisition object in the determined projection region, determine second color information according to the first color information, and project the second information into the projection region by using the second color information, wherein the first color information and the second color information satisfy a third preset condition.

Further, the processing module includes:

a first processing unit, configured to perform a translation process on the first information and take the translation result as the second information;

a second processing unit, configured to perform a searching process on the first information, and obtain a search result related to the first information as the second information; and

a third processing unit, configured to perform a recognizing and extracting process on the first information, and obtain result information corresponding to a recognition and extraction result as the second information.

Further, the processing module further includes:

a fourth processing unit, configured to perform a searching process on the result information corresponding to the recognition and extraction result, generate third information, and project the third information into the projection region.

It should be noted that, the relationship terminologies such as first, second and the like are only used herein to distinguish an entity or operation from another entity or operation, and it is not necessarily required or implied that there is any actual relationship or order between those entities and operations. Moreover, the terminologies of ‘comprise’, ‘include’, and any other variants are intended to cover the non-exclusive inclusion and the processes, methods, articles or equipment including a series of elements not only include those elements but also include other elements that are not expressively listed or also include the elements inherent in the processes, methods, articles or equipment. Without any other restrictions, the elements defined by the statement ‘including a (an) . . . ’ do not exclude that additional ones of the same element also exist in the processes, methods, articles or equipment including the elements.

The invention may be described in the general context of computer-executable instructions, such as program modules, executed by a computer. Generally, the program module includes routine, program, object, component, data structure and so on to perform a particular task or implement a particular abstract data types. The invention may also be implemented in a distributed computing environment. In the distributed computing environment, a task is executed by remote processing devices connected via a communication network. In the distributed computing environment, program modules may be located in local and remote computer storage medium, including storage devices.

Preferable embodiments of the present invention are described above. It should be noted that several improvements and enhancements could be made by those skilled in the art without departing from the principle of the present invention, which should be considered as falling within the scope of the present invention.

1. An information display method applicable in an electronic device comprising an image projecting module and an image acquiring module, a projection region of the image projecting module at least partially overlapping with an acquiring region of the image acquiring module, the method comprising:
determining a first image acquiring region in which an acquisition object is at least partially located;
acquiring, by the image acquiring module, at least a part of the acquisition object in the first image acquiring region and determining a first processing object;
performing an image recognizing process on the first processing object and generating first information;
processing the first information and generating second information;
determining the projection region in which the acquisition object is at least partially located; and
projecting, by the image projecting module, the second information into the projection region.

2. The method according to claim 1, further comprising:
projecting, by the image projecting module, a boundary of a second image acquiring region, wherein the second image acquiring region is located within the first image acquiring region;
determining a first processing object comprising:
determining an image in the second image acquiring region as the first processing object.

3. The method according to claim 2, further comprising:
adjusting the size of the boundary of the second image acquiring region.

4. The method according to claim 3, wherein adjusting the size of the boundary of the second image acquiring region comprises:
receiving a first input instruction, and adjusting the size of the boundary of the second image acquiring region according to the first input instruction, wherein the first input instruction is a keystroke input or a gesture input; or
recognizing the image in the second image acquiring region, and adjusting the size of the boundary of the second image acquiring region according to a recognition result.

5. The method according to claim 1, wherein determining a first processing object comprises:
recognizing an acquired image in the first image acquiring region, and obtaining the first processing object according to a first preset condition, wherein the first preset condition is a preset indicator or preset information of interest.

6. The method according to claim 1, wherein determining the projection region comprises:
obtaining a location where the first processing object is located in the first image acquiring region or a location where the first processing object is located at the acquisition object, and determining a location of the projection region according to the obtained location.

7. The method according to claim 1, wherein determining the projection region comprises:
searching for a region satisfying a second preset condition and determining the region as the projection region.

8. The method according to claim 1, wherein projecting by the image projecting module the second information into the projection region comprises:
obtaining first color information of the acquisition object in the determined projection region, and determining second color information according to the first color information, wherein the first color information and the second color information satisfy a third preset condition; and
projecting the second information into the projection region by using the second color information.

9. The method according to claim 6, wherein the first color information is background color information of the acquisition object.

10. The method according to claim 1, wherein processing the first information and generating second information comprises any one of the following steps:
performing a translation process on the first information, and taking a translation result as the second information;
performing a searching process on the first information, and acquiring a search result related to the first information as the second information; and
performing a recognizing and extracting process on the first information, and obtaining result information corresponding to a recognition and extraction result as the second information.

11. The method according to claim 10, further comprising:
performing a searching process on the result information corresponding to the recognition and extraction result, generating third information, and projecting the third information into the projection region.

12. An information display device comprising an image projecting module and an image acquiring module, a projection region of the image projecting module at least partially overlapping with an acquiring region of the image acquiring module, the device comprising:
a first determining module, configured to determine a first image acquiring region in which an acquisition object is at least partially located;
an image acquiring module, configured to acquire at least a part of the acquisition object in the first image acquiring region and determine a first processing object;
an image recognizing module, configured to perform an image recognizing process on the first processing object and generate first information;
a processing module, configured to process the first information and generate second information;
a second determining module, configured to determine the projection region in which the acquisition object is at least partially located; and
an image projecting module, configured to project the second information into the projection region.

13. The device according to claim 12, wherein the image projecting module is further configured to project a boundary of a second image acquiring region, wherein the second image acquiring region is located within the first image acquiring region; and
the image acquiring module is further configured to determine an image in the second image acquiring region as the first processing object.

14. The device according to claim 13, further comprising:
an adjusting module, configured to adjust the size of the boundary of the second image acquiring region.

15. The device according to claim 14, wherein the adjusting module comprises:
a first adjusting module, configured to receive a first input instruction and adjust the size of the boundary of the second image acquiring region according to the first input instruction, wherein the first input instruction is a keystroke input or a gesture input; and
a second adjusting module, configured to recognize, by using the image recognizing module, the image in the second image acquiring region and adjust the size of the boundary of the second image acquiring region according to a recognition result.

16. The device according to claim 12, wherein the image acquiring module is further configured to recognize an acquired image in the first image acquiring region, and obtain the first processing object according to a first preset condition, wherein the first preset condition is a preset indicator or preset information of interest.

17. The device according to claim 12, wherein the second determining module comprises:
a first determining unit, configured to obtain a location where the first processing object is located in the first image acquiring region or obtain a location where the first processing object is located at the acquisition object, and determine a location of the projection region according to the obtained location;
a second determining unit, configured to search for a region satisfying a second preset condition and determine the region as the projection region; and
a third determining unit, configured to obtain a location where the first processing object is located at the acquisition object, and determine the region of the location as the projection region.

18. The device according to claim 12, wherein the image projecting module is further configured to obtain first color information of the acquisition object in the determined projection region, determine second color information according to the first color information, and project the second information into the projection region by using the second color information, wherein the first color information and the second color information satisfy a third preset condition.

19. The device according to claim 12, wherein the processing module comprises:
a first processing unit, configured to perform a translation process on the first information and take the translation result as the second information;
a second processing unit, configured to perform a searching process on the first information, and obtain a search result related to the first information as the second information; and
a third processing unit, configured to perform a recognizing and extracting process on the first information, and obtain result information corresponding to a recognition and extraction result as the second information.

20. The device according to claim 19, wherein the processing module further comprises:
a fourth processing unit, configured to perform a searching process on the result information corresponding to the recognition and extraction result, generate third information, and project the third information into the projection region.
